(19) United States
(12) Patent Application Publication
(10) Pub. No.: US 2009/0117428 A1
(43) Pub. Date: May 7, 2009

(54) Condensation device for a fuel cell

(76) Inventors: Chien-An Chen, Taipei (TW); Wen-Jui Chuang, Taipei (TW); Chien-Chou Chen, Taipei (TW)

Correspondence Address: G. LINK CO. LTD., 3550 BELL ROAD, MINOOKA, IL, 60447, US

(21) Appl. No.: 11/365,618

(22) Filed: Mar. 2, 2006

(51) Int. Cl. H01M 8/04

(52) U.S. Cl. 429/26

(57) ABSTRACT

A condensation device for a fuel battery provides a condensation main member. The condensation main member has an opening at two lateral sides thereof and one of the lateral sides is joined to a fuel battery for a gas entering via one of the openings and removing via another one of the openings. A turnabout path is defined in the condensation main member for increasing heat dissipating surface area being impinged by the gas such that heat energy of the gas conducts to the outer surface of the condensation main member to perform heat exchange with outside air and moisture in the gas is reduced temperature thereof to condense as water for being recycled and reused.

### BACKGROUND OF THE INVENTION

1. Field of the Invention

The present invention is related to a condensation device for a fuel cell and particularly to a condensation device, which is capable of guiding heat outward and condensing high heat and humidity gas produced while the fuel cell being in operation without consuming extra energy under conditions of limited volume of the fuel cell and limited space available for the condensation device.

2. Brief Description of the Related Art

It is known that various portable electronic information products have been developed due to technologies related to electronics, communication and internet progressing rapidly. Usually, the portable products need batteries as power source for supplying electric energy. But, the batteries have limited capacities and become exhausted after being used a period of time. In order to overcome the preceding deficiency of the ordinary batteries, a method for making fuel cell has been disclosed in Taiwanese Patent No. 1241048. The fuel in the cell is a methyl alcohol solution or pure methyl alcohol and a chemical reaction is processed to transfer chemical energy to electric power output. Comparing to the conventional power generation, methyl alcohol cell provides advantages such as low pollution, high energy intensity and higher energy transfer density.

When the fuel battery is in operation, preferable effect can be reached under conditions of proper work temperature and humidity. Thus, structure of the fuel cell has passages for gas and often needs active cooling component such as cooling chips or guiding heat pipes for reducing temperature in addition to having cooling passages for maintaining the fuel cell at a proper temperature. However, gross power consumption of all components in the fuel cell system is an important factor needed to consider to the entire design. How to design a cooling device with no energy consumption and high efficiency is worth us to care. Besides, how to recycle and reuse moisture in the high heat and humidity gas produced during the fuel cell being in operation is a problem worth us to solve too.

### SUMMARY OF THE INVENTION

Accordingly, an object of the present invention is to provide a condensation device for a fuel cell, which is capable of condensing high heat and humidity gas produced at the time of the fuel cell in operation without consuming extra energy.

Another object of the present invention is to provide a condensation device for a fuel cell in which a turnabout path is defined to increase heat dissipating surface area for the gas with high heat and humidity such that cooling effect is promoted greatly.

A further object of the present invention is to provide a condensation device for a fuel cell with which the gas with high heat and humidity can be reduced temperature thereof and condense moisture inside as water by means of the gas impinging the condensation device such that the gas can dried and the water can be recycled by the fuel battery.

A further object of the present invention is to provide a condensation device for a fuel cell in which a fan can be employed to remove the dried gas for increasing air flow and enhancing effect of heat dissipation and it avoids the fan being subjected to the high heat and humidity gas for enhancing reliability and life span of the fan.

In order to achieve the preceding objects, a condensation device for a fuel battery according to the present invention provides a condensation main member. The condensation main member has an opening at two lateral sides thereof and one of the lateral sides is joined to a fuel battery for a gas entering via one of the openings and removing via another one of the openings. A turnabout path is defined in the condensation main member for increasing heat dissipating surface area being impinged by the gas such that heat energy of the gas conducts to the outer surface of the condensation main member to perform heat exchange with outside air and moisture in the gas is reduced temperature thereof to condense as water for being recycled and reused.

### BRIEF DESCRIPTION OF THE DRAWINGS

The detail structure, the applied principle, the function and the effectiveness of the present invention can be more fully understood with reference to the following description and accompanying drawings, in which:

FIG. 1 is an exploded perspective view illustrating an application of the first embodiment of a condensation device for a fuel cell according to the present invention;

FIG. 2 is a sectional perspective view of the first embodiment of a condensation device for a fuel cell according to the present invention along line A-A in FIG. 1;

FIG. 3 is a plan sectional view of the first embodiment of a condensation device for a fuel cell according to the present invention along line A-A in FIG. 1;

FIG. 4 is a sectional view illustrating an alternative other than FIG. 3;

FIG. 5 is a sectional view illustrating another alternative other than FIG. 4;

FIG. 6 is a sectional view illustrating a further alternative other than FIG. 5; and

FIG. 7 is a sectional perspective view of the second embodiment of a condensation device for a fuel cell according to the present invention along line A-A in FIG. 1.

### DETAILED DESCRIPTION OF THE INVENTION

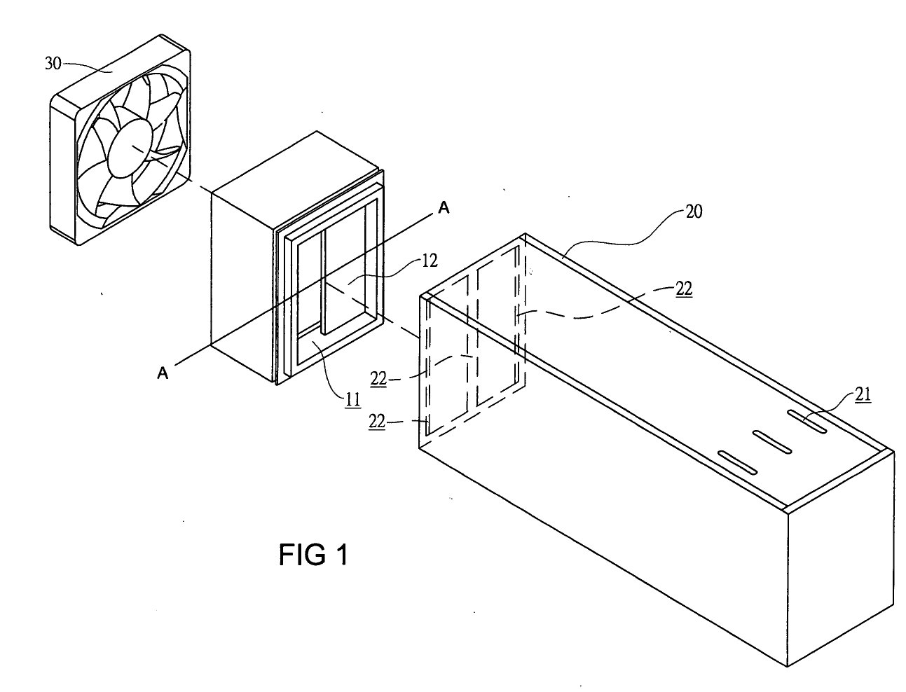

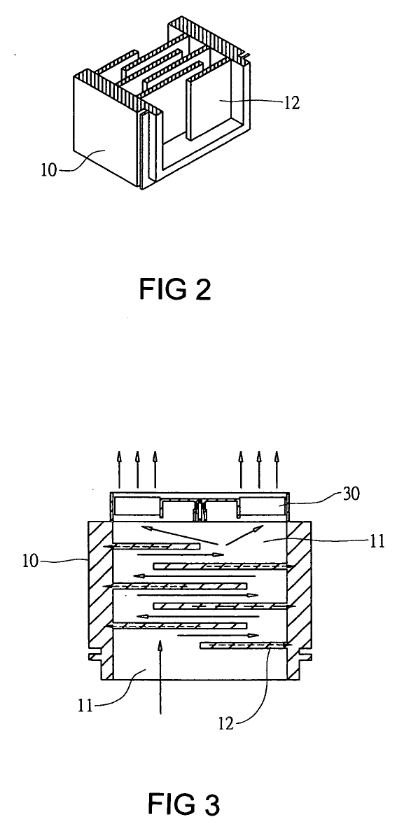

Referring to FIGS. 1 and 2, the first embodiment of a condensation device for a fuel cell according to the present invention provides a main condensation member 10, which is attached to a lateral side of a fuel cell 20. The fuel cell has an inlet 21 and an outlet 22 for air being able to enter a cooling channel (not shown in the figures) defined by the fuel cell 20 and flow toward the outlet 22 for guiding heat energy and moisture produced while the fuel cell 20 being in operation. The air receives the heat energy and mixes the moisture to combine a gas with high moisture and heat and it will be designated as the gas hereinafter.

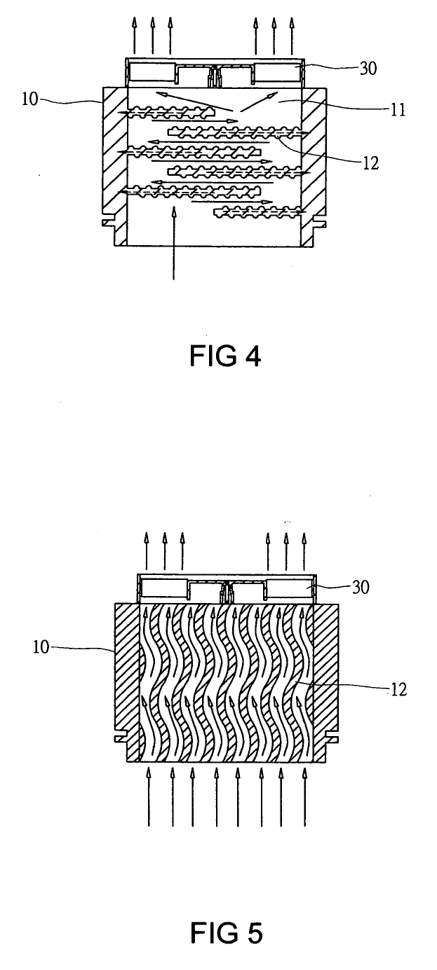

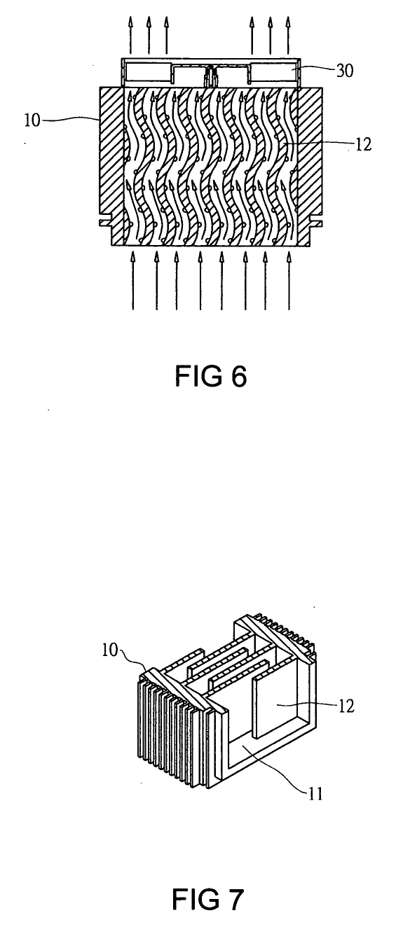

When the gas passes through the outlet 22 to impinge or hit the condensation main member 10, it is capable of carrying and dissipating the heat energy. It is feasibly implemented that the condensation main member 10 has a case member with an opening 11 at two lateral sides thereof and the outlet 22 corresponds to the opening 11 of the case member at one of the two lateral sides to allow the gas entering the condensation main member 10 via the opening 11 at one of the lateral sides thereof and leaving the condensation main member 10 via the opening 11 at another one of the lateral sides thereof. The inner wall of the condensation main member 10 provides a turnabout path as shown in FIG. 3 or wave paths as shown in FIG. 5 to increase cooling area hit by the gas such that effect of heat dissipation can be promoted greatly. Besides, partitions 12, which form the turnabout path or wave paths can be made with uneven outer surfaces as shown in FIG. 4 or toothed outer surfaces as shown in FIG. 6 to further increase cooling areas for accelerating speed of heat dissipation. Alternatively, other types of outer surfaces can be employed except the preceding two types of outer surfaces.

When the gas hits the inner walls of the condensation main member 10 and/or passes through the turnabout path or the wave paths, temperature of the high heat in the gas can be reduced and the moisture in the gas can condensed as water. That is, the gas hits the inner walls of the condensation main member 10, which provides much lower temperature than the gas and generates heat transfer, such that the heat in the gas can conduct to outer surface of the condensation main member 10 to perform heat transfer between the foreign air for releasing heat to the atmosphere and the turnabout path and the wave paths provided in the condensation main member 10 can increase the area hit by the gas to not only enhance heat dissipating effect but also to condense the moisture in the gas for being recycled and reused by the fuel cell 20. In this way, it is necessary to fill up methyl alcohol in the fuel cell 20 only without need of filling water.

Besides, the outer edge of the condensation main member 10 can be provided with at least a cooling fin 13 as shown in FIG. 7 to expand the outer surface area of heat exchange with the foreign air 2 such that the heat energy is capable of being removed rapidly for promoting effect of heat dissipation significantly. If a fan 30 is mounted to another side of the condensation main member 10 instead of being mounted to another side of the fuel cell 20, the gas is able to flow speedily. Meanwhile, the condensation main member 10 is able to block the moisture in the gas to avoid the fan 30 being subjected to the gas with high humidity such that the fan 30 is able to enhance both reliability and life span thereof.

It is appreciated that the invention has the following advantages:

1. It is not necessary to add additional devices such as guiding heat pipes and cooling chips to the condensation main member of the invention so that it is capable of saving energy and cost.

2. Excellent heat transfer can be achieved due to the effect of impingement.

3. Due to turnabout paths or wave paths provided in the condensation main member 10 allowing more gas impinging the inner walls thereof, it promotes the effect of heat dissipation significantly and makes the gas being condensed as water for being recycled and reused.

4. It prevents the fan 30 from being subjected to the high humidity gas to enhance both the reliability and life span thereof.

While the invention has been described with referencing to preferred embodiments thereof, it is to be understood that modifications or variations may be easily made without departing from the spirit of this invention, which is defined by the appended claims.

What is claimed is:

1. A condensation device for a fuel battery, comprising:
a condensation main member, providing an opening at two lateral sides thereof and one of the lateral sides being joined to a fuel battery for a gas entering via one of the openings and removing via another one of the openings; and
a turnabout path, being defined in the condensation main member for increasing heat dissipating surface area being impinged by the gas such that heat energy of the gas conducts to the outer surface of the condensation main member to perform heat exchange with outside air and moisture in the gas is reduced temperature thereof to condense as water for being recycled and reused.

2. The condensation device for a fuel battery as defined in claim 1, wherein the turnabout path is formed with a plurality of flat partitions attached to the inner walls.

3. The condensation device for a fuel battery as defined in claim 1, wherein the turnabout path is formed a plurality of wave partitions attached to the inner walls.

4. The condensation device for a fuel battery as defined in claim 2, wherein the outer surfaces of the partitions are uneven.

5. The condensation device for a fuel battery as defined in claim 4, wherein the outer surfaces of the partitions provide a plurality of recesses and projections.

6. The condensation device for a fuel battery as defined in claim 4, wherein the partitions provides toothed outer surfaces.

7. The condensation device for a fuel battery as defined in claim 1, wherein the condensation main member provides at least a cooling fin at the outer side thereof.

8. The condensation device for a fuel battery as defined in claim 4, wherein the condensation main member provides at least a cooling fin at the outer side thereof.
